(19) United States
(12) Patent Application Publication
(10) Pub. No.: US 2013/0179481 A1
(43) Pub. Date: Jul. 11, 2013

(54) MANAGING OBJECTS STORED IN STORAGE DEVICES HAVING A CONCURRENT RETRIEVAL CONFIGURATION

(71) Applicant: Tonian Inc., Natania (IL)

(72) Inventor: Ben Zion HALEVY, Tel-Aviv (IL)

(73) Assignee: Tonian Inc., Natania (IL)

(21) Appl. No.: 13/733,166

(22) Filed: Jan. 3, 2013

Related U.S. Application Data
(60) Provisional application No. 61/585,283, filed on Jan. 11, 2012.

(51) Int. Cl. G06F 17/30

(52) U.S. Cl. CPC G06F 17/30094
USPC 707/827

(57) ABSTRACT

A data storage method for storing data in a plurality of storage devices having a concurrent retrieval configuration. The data storage method comprises storing data in a plurality of data container objects distributed among in a plurality of storage devices, storing a plurality of metadata container objects and a plurality of metadata directory objects in the plurality of storage devices, wherein each metadata directory object indexes a group of the plurality of metadata container objects and each the metadata container object comprises metadata including storage location data of at least one of the plurality of data container objects and the plurality of metadata directory objects, and managing access to the plurality of data container objects by locally executing a plurality of data control requests by the plurality of storage devices, by a module installed in the plurality of storage devices or in a proxy.

### RELATED APPLICATION

This application claims the benefit of priority under 35 USC §119(e) of U.S. Provisional Patent Application No. 61/585,283 filed Jan. 11, 2012, the contents of which are incorporated herein by reference in their entirety.

### FIELD AND BACKGROUND OF THE INVENTION

The present invention, in some embodiments thereof, relates to concurrent retrieval storage and, more particularly, but not exclusively, to managing objects stored in storage devices having a concurrent retrieval configuration.

During the last years, the storage input and/or output (I/O) bandwidth requirements of clients have been rapidly outstripping the ability of network file servers to supply them. This problem is being encountered in installations running according to network file system (NFS) protocol. In order to overcome this problem, parallel NFS (pNFS) has been developed. pNFS allows clients to access storage devices directly and in parallel. The pNFS architecture increases scalability and performance compared to former NFS architectures. This increment is achieved by the separation of data and metadata and using a metadata server out of the data path.

In use, a pNFS client initiates data control requests on the metadata server, and subsequently and simultaneously invokes multiple data access requests on the cluster of data servers. Unlike in a conventional NFS environment, in which the data control requests and the data access requests are handled by a single NFS storage server, the pNFS configuration supports as many data servers as necessary to serve client requests. Thus, the pNFS configuration can be used to greatly enhance the scalability of a conventional NFS storage system. The protocol specifications for the pNFS can be found at itef.org, see NFS4.1 standards and Requests For Comments (RFC) 5661-5664 which include features retained from the base protocol and protocol extensions. Major extensions such as sessions, and directory delegations, External Data Representation Standard (XDR) Description, a specification of a block based layout type definition to be used with the NFSv4.1 protocol, and an object based layout type definition to be used with the NFSv4.1 protocol.

### SUMMARY OF THE INVENTION

According to some embodiments of the present invention, there is provided a data storage method for storing data in a plurality of storage devices having a concurrent retrieval configuration. The method comprises storing data in a plurality of data container objects distributed among in a plurality of storage devices, storing a plurality of metadata container objects and a plurality of metadata directory objects in the plurality of storage devices, wherein each metadata directory object indexes a group of the plurality of metadata container objects and each the metadata container object comprises metadata including storage location data of at least one of the plurality of data container objects and the plurality of metadata directory objects, and managing access to the plurality of data container objects by executing a plurality of data control requests using storage location data stored in the plurality of metadata container objects and the plurality of metadata container directory objects.

Optionally, the data storage further comprises dividing the data to a plurality of segments according to a storage topology and storing each the segment in another of the plurality of data container objects.

More optionally, the managing comprises managing concurrent retrieval of at least some of the plurality of segments by locally executing the plurality of data control requests simultaneously on at least some of the plurality of storage devices.

More optionally, the storage topology is a striping topology.

More optionally, the storage topology is a concatenation topology.

According to some embodiments of the present invention, there is provided a data storage method for storing data in a plurality of storage devices having a concurrent retrieval configuration. The data storage method comprises distributing among a plurality of storage devices a plurality of metadata directory objects each indexing a group of a plurality of metadata container objects, a plurality of data container objects, and the plurality of metadata container objects, each the metadata container object comprises metadata including storage location data of at least one of the plurality of data container objects and the plurality of metadata directory objects, receiving at a metadata switch unit a metadata request with a logical address of data from a client, sending at least one of the plurality of storage devices a request for respective the metadata of the data from a respective of the plurality of metadata containers, receiving the metadata from the respective metadata container, and forwarding the metadata to the client as a response to the data address request.

Optionally, the concurrent retrieval configuration is a parallel network file system (pNFS) configuration, the metadata switch unit is a metadata server and the plurality of storage devices are plurality of data servers.

Optionally, at least some of the plurality of metadata container objects comprises storage location data each of a group of the plurality of data containers each stored in a different storage device of the plurality of storage devices.

More optionally, the group storing a plurality of segments of a segmented file, each the data container store a different the segment.

More optionally, the storage location data is a storage topology mapping members of the group.

Optionally, at least some of the plurality of metadata container objects comprises storage location data of a group of the plurality of data containers, the group storing a plurality of copies of a file in the plurality of storage devices, each the data container being stored in another of the plurality of storage devices.

According to some embodiments of the present invention, there is provided a system for storing data in a plurality of storage devices having a concurrent retrieval configuration. The system comprises a plurality of storage devices which store a plurality of metadata directory objects each indexing a group of a plurality of metadata container objects, a plurality of data container objects, and the plurality of metadata container objects, each the metadata container object comprises metadata including storage location data of at least one of the plurality of data container objects and the plurality of metadata directory objects, a metadata switch unit coupled with the plurality of storage devices and is configured to: receive a metadata request with a logical address of data from a client, send at least one of the plurality of storage devices a request for metadata of the data container from a respective of the plurality of metadata containers, receive the metadata from a respective the metadata container of at least one of the plurality of data container objects, the at least one data container object stores the data, and forward the metadata as a response to the data address request.

Optionally, the concurrent retrieval configuration is a parallel network file system (pNFS) configuration, the metadata switch unit is a metadata server and the plurality of storage devices are plurality of data servers.

According to some embodiments of the present invention, there is provided a data storage method for storing data in a plurality of storage devices having a concurrent retrieval configuration. The method comprises allocating for each of a plurality of virtual data pools a plurality of storage portions each of another of a plurality of storage resources having a plurality of different quality of service (QoS) levels and storing in the plurality of storage portions of each the virtual data pool at least one virtual file system having a plurality of data containers, metadata of the plurality of data containers, and a plurality of metadata directories organizing the metadata.

Optionally, the plurality of metadata directories index a group of the plurality of metadata containers and each the metadata container object comprising metadata of at least one of the plurality of data container objects and objects hosting the plurality of metadata directories.

Optionally, the allocating comprises allocating the plurality of storage portions for storing a plurality of data segments of a file.

More optionally, the allocating comprises stripe-distributing the file to a plurality of stripes each storing one of the plurality of data segments.

Optionally, the allocating comprises receiving a plurality of multi-tiered service level assurance (SLA) requirements of a plurality of clients and associating each the client with one of the plurality of virtual data pools, and performing the allocating according to respective the multi-tiered SLA requirements.

Optionally, the method further comprises monitoring access to the plurality of data containers and migrating the plurality of data containers between the plurality of storage portions according to the monitoring.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data.

Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a storage system that includes metadata switch unit the manages a plurality of file system objects which include metadata containers, files, and file directories distributed in the plurality of storage devices, according to some embodiments of the present invention;

FIG. 2 is a schematic illustration depicting an exemplary object store comprising exemplary file system objects stored in exemplary storage devices and exemplary logical relations therebetween, according to some embodiments of the present invention;

FIGS. 3A-3B are schematic illustrations of a metadata container which includes location storage data of a plurality of data containers which include segments of a file distributed according to different storage topologies, according to some embodiments of the present invention;

FIG. 3C is a schematic illustration of a metadata container which includes location storage data of a plurality of data containers which include copies of a file or a segment of a file, according to some embodiments of the present invention; and

FIG. 4 is a flowchart of a method of providing control data, metadata, to a client, such as a pNFS client, and communication between the metadata switch unit and the storage devices during a control data request processing operation, according to some embodiments of the present invention.

### DESCRIPTION OF EMBODIMENTS OF THE INVENTION

The present invention, in some embodiments thereof, relates to concurrent retrieval storage and, more particularly, but not exclusively, to managing objects stored in storage devices having a concurrent retrieval configuration.

According to some embodiments of the present invention, there are provided methods and systems of managing the storage of data in a plurality of storage devices having a concurrent retrieval configuration, for example in a pNFS storage system, in a manner that allows the storage devices or logical file system modules which are installed therein or on proxies to execute control data requests, such as lookup and layout get requests, locally and not on an external metadata server. This allows avoiding a bottle neck in the processing of control data requests at the metadata server. The methods and systems are based on managing an object store having a plurality of objects which are distributed among the storage devices. The object store includes a plurality of data container objects, each stores a file or a file segment, a plurality of metadata container objects, and a plurality of metadata directory objects. Each metadata directory object indexes one or more metadata container objects and each metadata container object comprises metadata, including storage location data, of one or more data container objects and/or a metadata directory object. Optionally, in use, a metadata switch unit, such as a metadata server, forwards data control requests to one of the storage devices or to logical file system modules which accordingly execute, optionally locally, one or more intermediate data control requests to acquire respective metadata from suitable metadata containers.

Optionally, metadata container objects store layout metadata which describe the storage topology of a number of data containers. Such layout metadata allows storing in the data containers segments of files according to storage topologies such as concatenation and striping topologies. Optionally, metadata container objects store layout metadata which describe the storage topology of a number of data containers which store file segments of a common file and/or copies thereof. In such a manner, data recoverability may be increased and route computing overhead may be reduced.

According to some embodiments of the present invention, there are provided methods and systems of managing multi-tiered virtual data pools among a plurality of storage devices having different quality of service (QoS) levels. In such embodiments, storage capacity from different virtual data pools may be allocated to clients according to different service level agreements. A multi tiered virtual data pool includes storage portions from different storage resources having different characteristics. This allows using the methods and systems to provide custom storage to different clients according to their needs, optionally dynamically.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

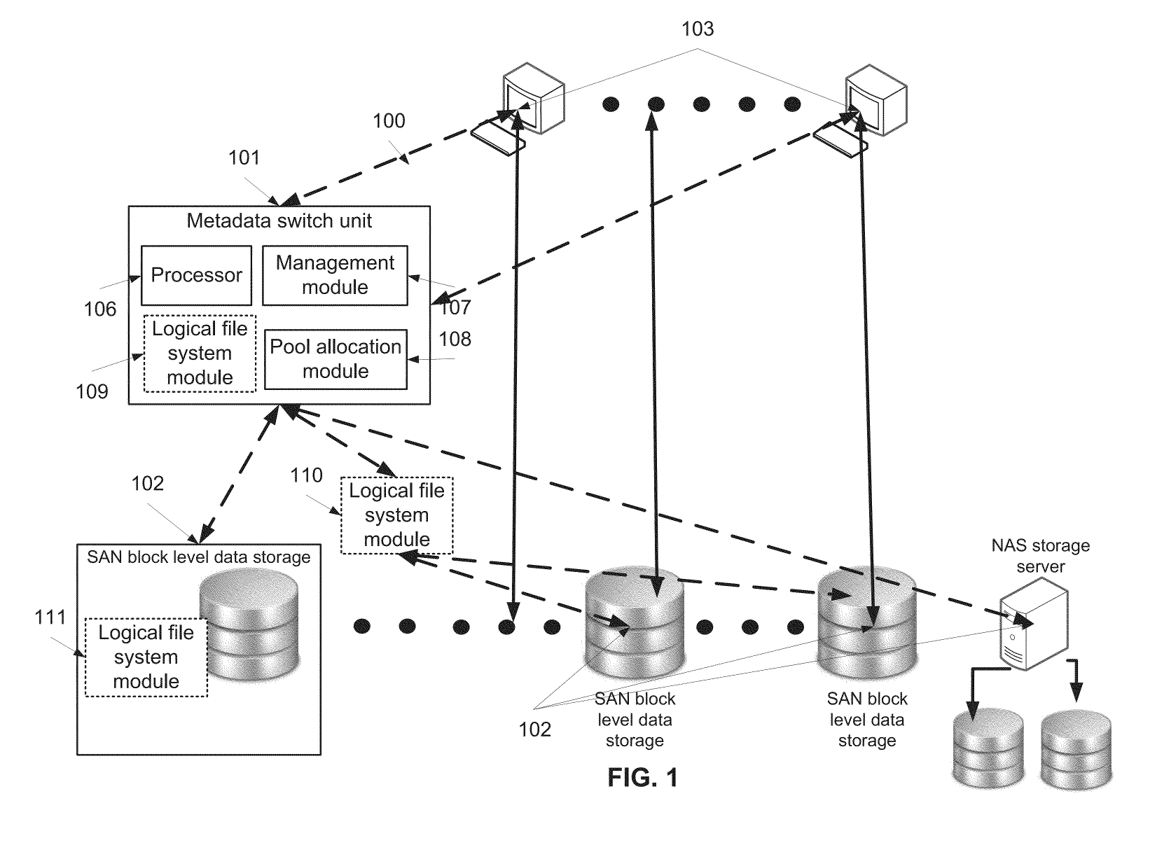

Reference is now made to FIG. 1, which is a schematic illustration of a storage system 100, optionally a concurrent retrieval configuration system 100, such as a pNFS storage system, that includes metadata switch unit 101 and a plurality of storage devices 102 which provide storage services to a plurality of concurrent retrieval clients 103, for example client terminals, where the metadata switch unit 101 manages a plurality of file system objects which include metadata containers, data containers, and metadata directories, distributed among the plurality of storage devices 102, according to some embodiments of the present invention. Optionally, the storage system 100 provides access to the file system objects in a concurrent retrieval configuration defined according to a protocol such as pNFS protocol.

Optionally, the metadata switch unit 101 and/or one or more of the storage devices 102 are implemented as virtual machines. In such embodiments, a number of storage devices 102 may be managed as virtual machines executed on a common host. Optionally, the metadata switch unit 101 and one or more of the storage devices 102, for example storage servers, are hosted on a common host, for example as virtual. For example machines

According to some embodiments of the present invention, a number of metadata switch units 101 are used. In such an embodiment, the metadata switch units 101 are coordinated, for example using a node coordination protocol. For brevity, a number of metadata switch units 101 are referred to herein as a metadata switch unit 101.

A client 103, which is optionally a pNFS client 103 capable of communicating according to pNFS protocol, may be, for example, a conventional personal computer (PC), a server-class computer, a laptop, a tablet, a workstation, a handheld computing or communication device, a hypervisor and/or the like. A storage device 102 is optionally a server, such as a file-level server, for example, a file-level server used in network attached storage (NAS) environment or a block-level storage server such as a server used in a storage area network (SAN) environment. Optionally, in order to communicate with the SAN storage devices 102 one or more logical file system modules may be executed on the metadata switch unit node 101, as shown at 109, on a proxy as shown at 110, and/or on the SAN storage devices as shown at 111. The logical file system module may be used for looking up, storing and retrieving data and metadata objects over block-based SAN storage devices, for example similarly to the described below.

The storage device 102 can include, for example, conventional magnetic or optical disks or tape drives; alternatively, they can include non-volatile solid-state memory, such as flash memory, and/or the like. Optionally, different storage devices 102 provide different quality of service levels (also referred to as tiers).

Optionally, pNFS configuration is implemented to allow concurrent retrieval of data stored in the pNFS storage system 100. In this pNFS configuration, the plurality of storage devices 102 simultaneously respond to multiple data requests from the clients 103. In use, the metadata switch system 100 handles data control requests, for example file lookup and open requests, and the plurality of storage devices 102 process data access requests, for example data writing and retrieving requests.

The metadata switch unit 101 manages a corpus of plurality of file system objects, which are distributed in the plurality of storage devices 102 and connected to one another via reference data stored in metadata dictionaries which index different metadata containers. A file system object is stored in any of the storage devices 102 and may include a data container, for example a file or a file segment, a metadata container which contains metadata pertaining to a data container, and a virtual metadata directory mapping metadata containers.

Optionally, the metadata switch unit 101 includes one or more processors 106, referred to herein as a processor, memory, communication device(s) (e.g., network interfaces, storage interfaces), and interconnect unit(s) (e.g., buses, peripherals), etc. The processor 106 may include central processing unit(s) (CPUs) and control the operation of the system 100. In certain embodiments, the processor 106 accomplishes this by executing software or firmware stored in the memory. The processor 106 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

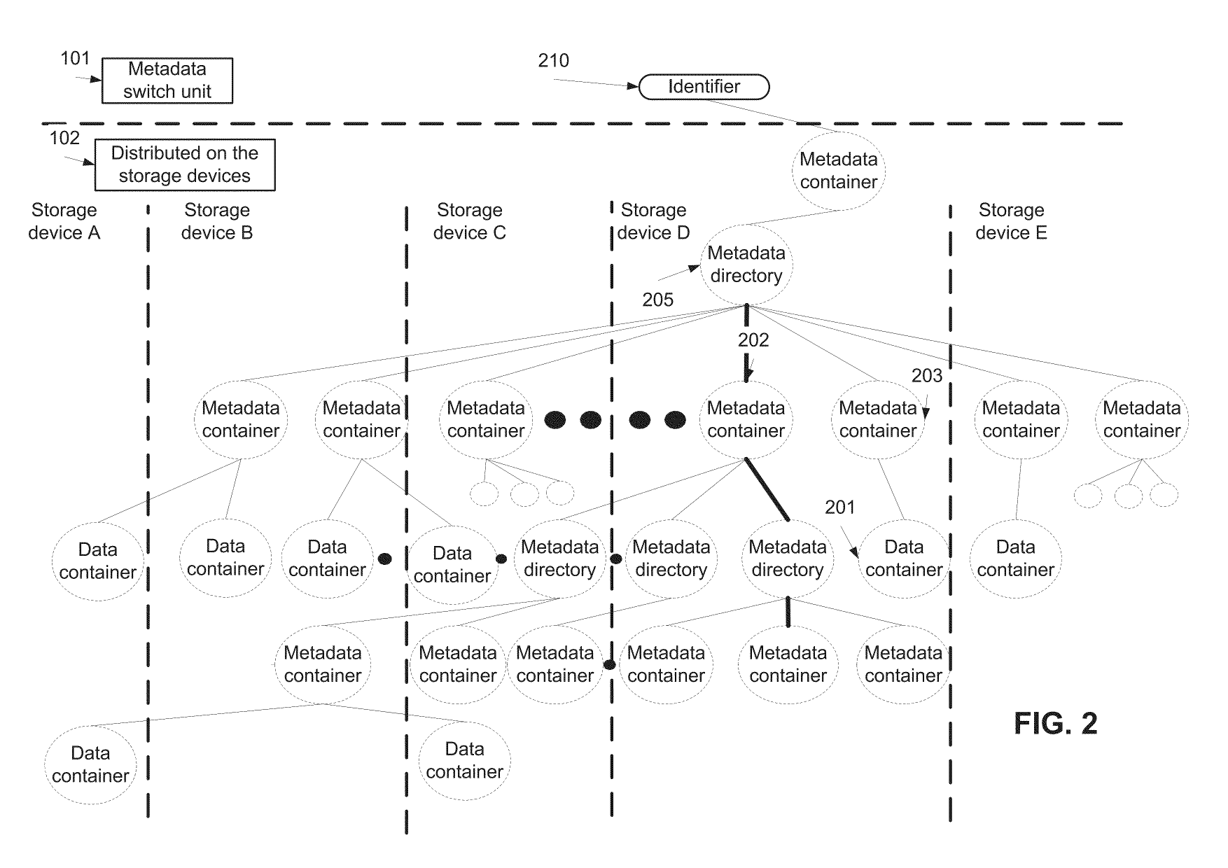

As further described below, the file system objects distributed among the storage devices 102 include both storage data, for example data containers and their data and virtual file system data organizing the data containers in the storage devices 102. In such embodiments, metadata for organizing data such as files, is not locally stored and managed on a metadata unit, for example the metadata switch system 101 and/or a metadata server under pNFS configuration, but rather stored in the storage devices 102 as data objects. For example, FIG. 2 is a schematic illustration depicting an object store (OBS) comprising a plurality of file system objects, which are stored in the storage devices 102, and exemplary connections therebetween, indicative of logical relations. In this schematic illustration exemplary file system objects are data containers 201, metadata directories 202, and metadata containers 203 (only one of each type is numerated to avoid unclarity). For brevity, a metadata directory and all the file system objects which are logically connected as children thereto (e.g. indexed by it or by file system objects indexed by it or by its logical children), may be referred to herein as a virtual file system. Optionally, the metadata switch unit 101 locally stores an identifier 210 indicative of the storage address of a metadata container of a root metadata directory of the OBS. Optionally, logical names of folders in a namespace are mapped to respective metadata directories in the OBS. In such an embodiment, a metadata directory include references to one or more metadata containers of metadata directories representing folders and/or one or more files which are referred to in the respective folders.

As exemplified in FIG. 2, a metadata container connects between metadata directories or between a metadata directory and one or more data containers. This provides a dataset which may be seen as a single layer dataset wherein files, metadata directories, and metadata containers are stored in a two dimensional (2D) vector. A metadata container may include a reference to a number of data containers which store segments of a common file. In such embodiments, the data containers may be distributed according to different storage topologies, optionally among a number of different storage devices, for example as described below.

The metadata container 202 includes metadata pertaining to one or more data containers or a metadata directory. For example, a metadata container includes a number of attributes, such as a storage location, a name, creation and modification dates, a size, and/or the like.

For example, a metadata container 202 includes self-identifying metadata records such as metadata versioning information records, metadata container type records, virtual file system identifier records, and/or metadata container identifier records. Additionally or alternatively, the metadata container 202 includes file system metadata records such as a file system object type record, a file system object attributes record, and/or list of <parent directory identifier, link name> back-pointer tuples. Additionally or alternatively, the metadata container 202 includes storage topology metadata records, such as storage topology type and respective parameters, concatenated|striped (RAID level) records, mirroring level records, and list of <object storage identifiers, object identifier records. Additionally or alternatively, the metadata container 202 includes a checksum of contents.

Optionally, when a number of more data containers are referred to by the metadata container, the metadata container includes layout metadata which describe storage topology of the data containers, for example as described below.

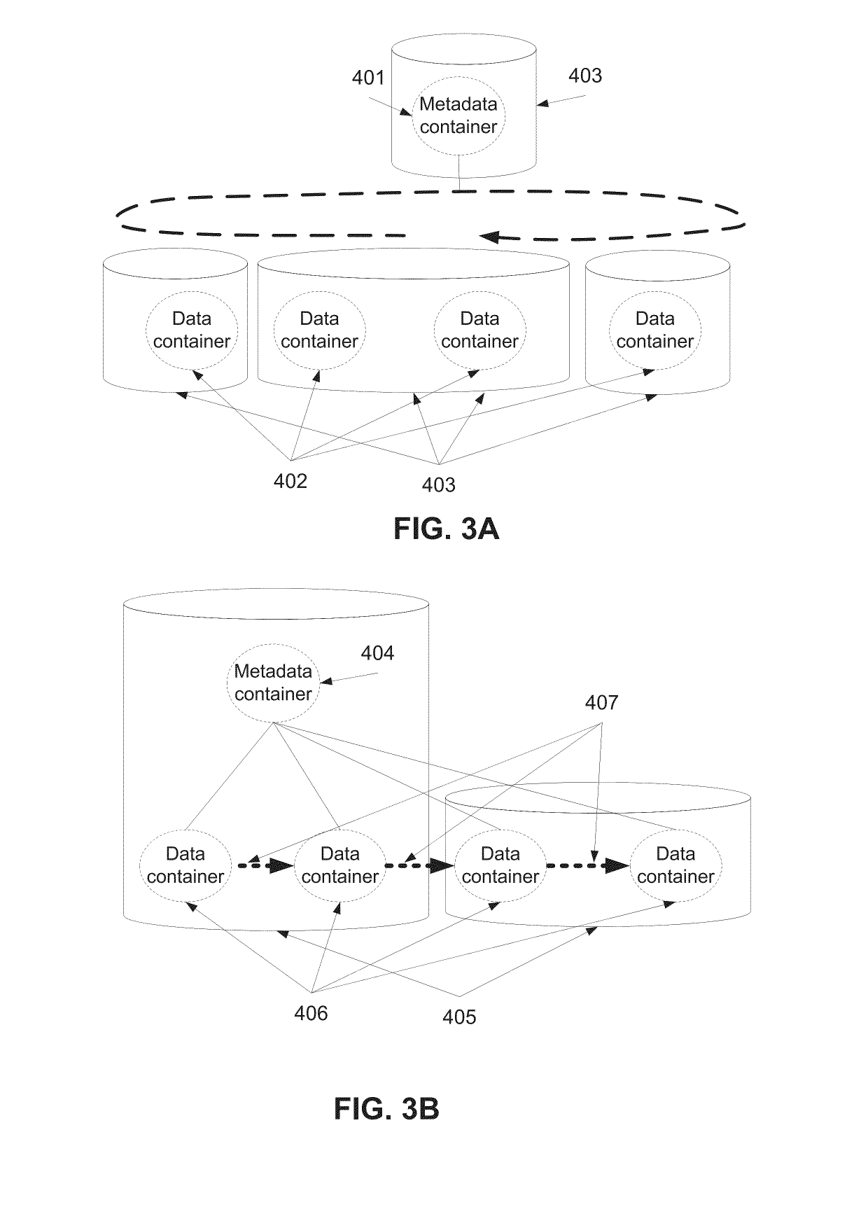

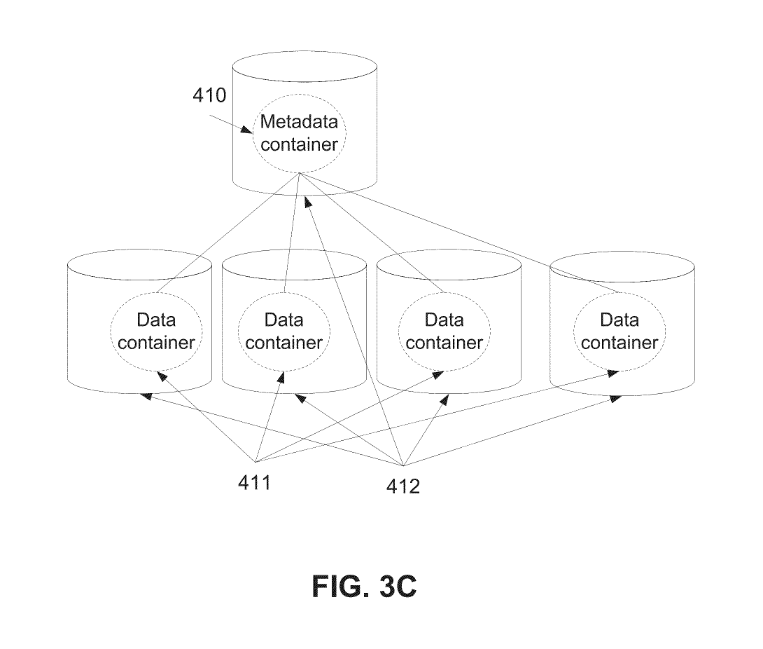

According to some embodiments of the present invention, each of one or more of the metadata containers includes storage topology of data segments, such as segments of a file. In such embodiments, the metadata container includes a layout metadata with storage location data of a particular set of data containers each store another of a set of segments of a segmented file among the storage devices 102. The layout metadata provides an outline for retrieving the distributed set of segments from the storage devices 102. The segments may be distributed among the storage devices 102, for example according to a pNFS methodology to facilitate an efficient parallel access thereto. For example, FIG. 3A depicts a metadata container 401 storing layout metadata that provides an outline for retrieving a distributed set of stripes stored in a plurality of different data containers 402, optionally distributed among a plurality of different storage devices 403. In such embodiments, the layout metadata includes striping parameters. This allows using a metadata container to include metadata having storage location data of data containers of segments of a file striped to a plurality of data containers, which are stored in different physical storage devices 103. In such a manner, when a client 103 requests access to a striped file, it may receive concurrent access to multiple respective objects, for example based on pNFS configuration.

Another example, is depicted in FIG. 3B which depicts a metadata container 401 storing layout metadata that provides an outline for retrieving a concatenating set of segment 406 which are optionally stored in a plurality of different data containers 405. In such embodiments the layout metadata includes the location storage data of each segment. The segments are concatenated in a certain logical order indicated by dashed arrows 407. Each data container 405 stores a different concatenated segment.

According to some embodiments of the present invention, each of one or more of the metadata containers includes storage topology of a plurality of copies of a file or a file segment, for example of a cache system or a backup system. In such a manner, a certain metadata container is used as a common metadata container of each one of copies. For example, FIG. 3C depicts an exemplary metadata container 410 with storage location data of a plurality of copies 411 of a certain file or a file segment, for example according to a minoring topology. The copies 411 are optionally distributed among a plurality of storage devices 412 to reduce route computing overhead and/or to increase availability and recoverability of data.

Optionally, the metadata switch unit 101 includes a storage control module 107 that manages the storage of files and optionally file segments in the OBS. In use, when the storage control module 107 receives a data control request from one of the clients, it forwards a respective intermediate data control request to be handled by the storage devices 102. The storage devices 102 process the respond to the respective intermediate data control request, facilitating the storage control module 107 to provide the requesting client with requested metadata without allocating substantial computational resources for locating it. The computational resources, which are required for responding the respective data control request, are provided by the storage devices 102 and not by the metadata switch unit 101 or any other metadata server. Moreover, as outlined above and described below, the metadata containers, which include metadata of the stored files, are stored in the storage devices 102. This reduces the memory management and allocation required from the metadata switch unit 101.

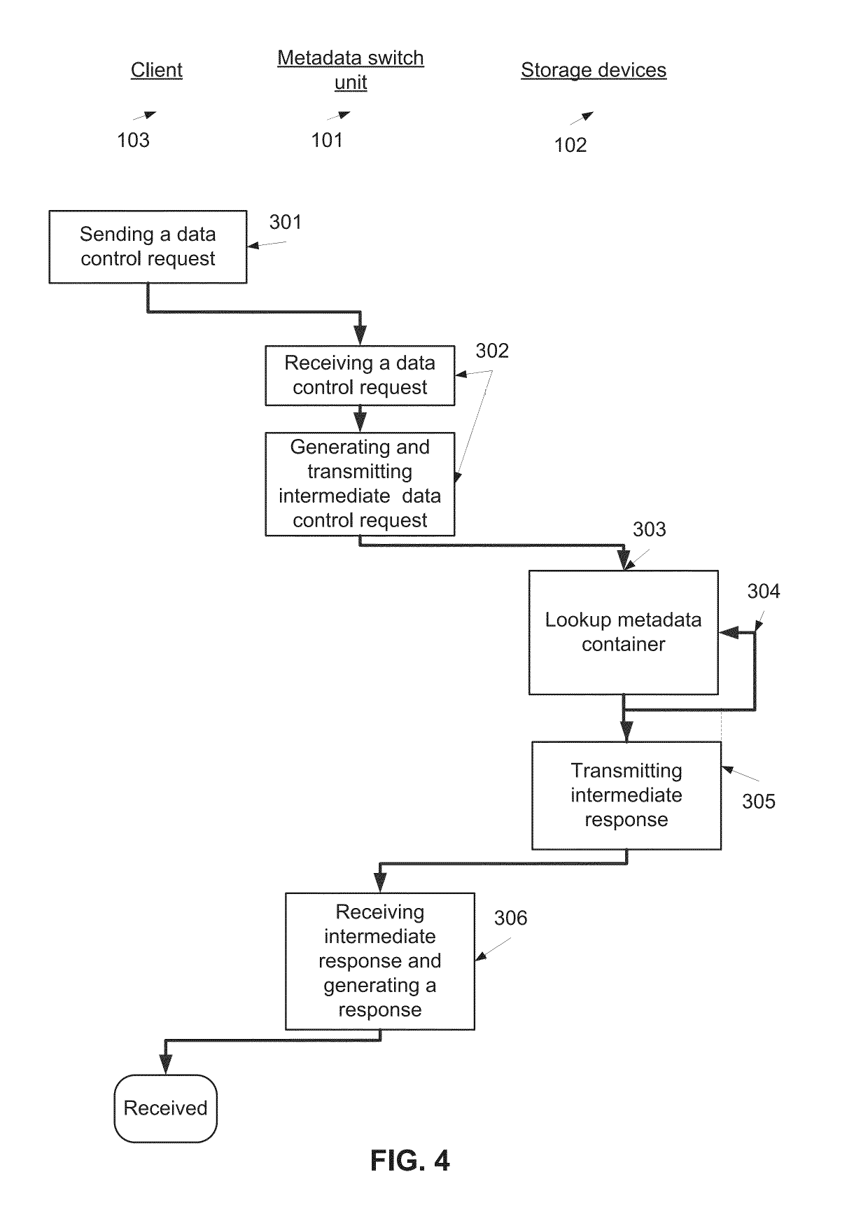

Reference is now also made to FIG. 4, which is a flowchart of a method 300 of providing control data, metadata, to a client, such as a pNFS client, and communication between the metadata switch unit 101 and the storage devices 102 during a control data request processing operation, according to some embodiments of the present invention.

First, as shown at 301, the metadata switch unit 101 receives a data control request from one of the clients 103, for example when the system 100 is arranged according to pNFS configuration. The data control request may be a LOOKUP+OPEN request for a file handle and state identifications (IDs) and/or a LAYOUTGET request for a layout. The request includes an external logical name given to the requested file, for example “\\root\subdirectory\X.doc”.

As shown at 302, the metadata switch unit 101 generates an intermediate control data request which includes the external logical name of the requested file. The intermediate request is transmitted to the storage node 102 that includes a storage address of a metadata container of a root metadata directory, for example see numeral 205 depicted in FIG. 2.

As shown at 303, the receiving storage node 102 extracts the logical name from the request and looks up the metadata container of the related file or a plurality of file segments which are indexed by a respective metadata container, for example as described above re FIGS. 3A-3C. The lookup is optionally performed according to one or more metadata directories.

As shown at 304, the file or file segments maybe located by the storage nodes which execute iterative LOOKUP requests, each using the logical name of another subdirectory thereof (in a hierarchical order) for looking up a respective metadata directory. For example, as depicted by bold lines in FIG. 2, the file may be located after two respective directories are being looked for. It should be noted that the file system objects may be stored on a number of different storage nodes 102.

Now, as shown at 305, the located metadata container, or a portion thereof, is transmitted in response to the intermediate request. As shown at 306, the metadata switch unit 101 receives the metadata container, or the portion thereof, and generates a response to the client, for example with a filehandle in response to a LOOKUP request or with a filehandle, type, and byte range in response to a LAYOUTGET request.

Reference is now made, once again, to FIG. 1. The storage devices 102 grant storage resources which can be segmented and managed separately and dynamically by the storage control module 107. Optionally, the storage control module 107 separately manages a plurality of different virtual data pools. Each virtual data pool is allocated with a certain capacity. For example, file system objects containing different stripes of a striped content are mapped to different virtual data pools, each having a respective capacity.

As described above, the system 100 may include a plurality of different storage devices having different characteristics, for example conventional magnetic or optical disks or tape drives and non-volatile solid-state memory, such as flash memory. Different storage devices provide different QoS and may comply with different service level assurance (SLA) requirements. According to some embodiments of the present invention, a virtual data pool is allocated with a certain storage space of a storage resource having a certain QoS level. In such an embodiment, the association of data with a certain virtual pool determines its QoS. Using a management interface, manual or automatic tiering may be achieved by migrating virtual file systems from one virtual data pool to another. For example, in an automatic tiering, data may be dynamically migrated among virtual data pools or between storage portions of a certain virtual data pool, according to respective application usage and workload which is monitored in real time. For example, the access to data containers may be monitored to determine the migration. Access to data containers may be recorded and/or logged in the respective metadata containers.

According to some embodiments of the present invention, the storage control module 107 may manage a plurality of virtual data pools allocated with storage resources having different characteristics. Optionally, a virtual data pool is allocated with a certain storage space (e.g. several gigabytes). Optionally, the virtual data pool allocation is managed by a pool management module 108 in the metadata switch unit 101.

As described above, file system objects of the OBS are distributed among the storage devices 102. The file system objects of the OBS include metadata directories mapping metadata containers with metadata data of files, the metadata containers and the files, the storage control module 107. In some a manner, a plurality of logically connected file system objects of a virtual data pool may include data, optionally segmented, metadata, and metadata organization data pertaining to a certain content that is managed under common rules and/or a certain virtual file system. Each virtual data pool may include a number of virtual file systems.

The file system objects of each virtual data pool may be physically stored in a number of different storage systems. Moreover, different virtual data pools may be managed according to different sets of storage rules. According to some embodiments of the present invention, the storage control module 107 manages virtual data pools having a multi-tiered QoS. In such a manner, the system may provide storage to clients according to a multi-tiered SLA and/or to assure a certain SLA by storing files in different storage devices according to an analysis of usage frequency, usage pattern, number of related access and/or control data requests and/or the like. For example, a virtual data pool may be assigned with two or more of a certain amount of guaranteed capacity, a certain amount of soft quota capacity where an administrator is notified when breached, and a certain amount of hard quota capacity where an error is reported when breached.

Optionally, the storage control module 107 distributes file system objects to a certain pool under the limitations of a set of rules associated therewith, for example as long as the virtual data pool has vacant resources that can provide a certain tier of QoS. Optionally, the storage control module 107 matches virtual file systems to virtual data pools according to vacant resources to assure compliance with SLAs associated with the virtual file systems.

Optionally, a striped content that comprises one or more file segments mapped in the OBS is stored in different storage devices that provide different QoS levels. In such a manner, different stripes of the striped content receive a different quality of service.

The storage system 100 may allocate a data storage pool to a certain client and/or a certain group of clients, referred to herein as a client, based on their SLA requirements. The storage system 100 may allocate a virtual data pool to a certain client based on security definitions.

Optionally, the system 100 further comprises a management engine which services a graphical user interface (GUI) and/or a command-line interface (CLI). The management engine manipulates the system configuration, retrieves system-wide status and statistics, executes management-level tasks, and/or sends administrator events in response to instructions from the GUI or the CLI.

It is expected that during the life of a patent maturing from this application many relevant systems and methods will be developed and the scope of the term a user interface, a GUI, a computing unit, a processor, and a storage device is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A data storage method for storing data in a plurality of storage devices having a concurrent retrieval configuration, comprising:
storing data in a plurality of data container objects distributed among in a plurality of storage devices;
storing a plurality of metadata container objects and a plurality of metadata directory objects in said plurality of storage devices, wherein each metadata directory object indexes a group of said plurality of metadata container objects and each said metadata container object comprises metadata including storage location data of at least one of said plurality of data container objects and said plurality of metadata directory objects; and
managing access to said plurality of data container objects by executing a plurality of data control requests using storage location data stored in said plurality of metadata container objects and said plurality of metadata container directory objects.

2. The data storage method of claim 1, further comprising dividing said data to a plurality of segments according to a storage topology and storing each said segment in another of said plurality of data container objects.

3. The data storage method of claim 2, wherein said managing comprises managing concurrent retrieval of at least some of said plurality of segments by locally executing said plurality of data control requests simultaneously on at least some of said plurality of storage devices.

4. The data storage method of claim 2, wherein said storage topology is a striping topology.

5. The data storage method of claim 2, wherein said storage topology is a concatenation topology.

6. A computer readable medium comprising computer executable instructions adapted to perform the method of claim 1.

7. A data storage method for storing data in a plurality of storage devices having a concurrent retrieval configuration, comprising:
distributing among a plurality of storage devices a plurality of metadata directory objects each indexing a group of a plurality of metadata container objects, a plurality of data container objects, and said plurality of metadata container objects, each said metadata container object comprises metadata including storage location data of at least one of said plurality of data container objects and said plurality of metadata directory objects;
receiving at a metadata switch unit a metadata request with a logical address of data from a client;
sending at least one of said plurality of storage devices a request for respective said metadata of said data from a respective of said plurality of metadata containers;
receiving said metadata from said respective metadata container; and
forwarding said metadata to said client as a response to said data address request.

8. The data storage method of claim 7, wherein the concurrent retrieval configuration is a parallel network file system (pNFS) configuration, said metadata switch unit is a metadata server and said plurality of storage devices are plurality of data servers.

9. The data storage method of claim 7, wherein at least some of said plurality of metadata container objects comprises storage location data each of a group of said plurality of data containers each stored in a different storage device of said plurality of storage devices.

10. The data storage method of claim 9, wherein said group storing a plurality of segments of a segmented file, each said data container store a different said segment.

11. The data storage method of claim 9, wherein said storage location data is a storage topology mapping members of said group.

12. The data storage method of claim 7, wherein at least some of said plurality of metadata container objects comprises storage location data of a group of said plurality of data containers, said group storing a plurality of copies of a file in said plurality of storage devices, each said data container being stored in another of said plurality of storage devices.

13. A system for storing data in a plurality of storage devices having a concurrent retrieval configuration, comprising:
a plurality of storage devices which store a plurality of metadata directory objects each indexing a group of a plurality of metadata container objects, a plurality of data container objects, and said plurality of metadata container objects, each said metadata container object comprises metadata including storage location data of at least one of said plurality of data container objects and said plurality of metadata directory objects;
a metadata switch unit coupled with the plurality of storage devices and is configured to:
receive a metadata request with a logical address of data from a client;
send at least one of said plurality of storage devices a request for metadata of said data container from a respective of said plurality of metadata containers;
receive said metadata from a respective said metadata container of at least one of said plurality of data container objects, said at least one data container object stores said data; and
forward said metadata as a response to said data address request.

14. The system of claim 13, wherein the concurrent retrieval configuration is a parallel network file system (pNFS) configuration, said metadata switch unit is a metadata server and said plurality of storage devices are plurality of data servers.

15. A data storage method for storing data in a plurality of storage devices having a concurrent retrieval configuration, comprising:
allocating for each of a plurality of virtual data pools a plurality of storage portions each of another of a plurality of storage resources having a plurality of different quality of service (QoS) levels; and
storing in said plurality of storage portions of each said virtual data pool at least one virtual file system having a plurality of data containers, metadata of said plurality of data containers, and a plurality of metadata directories organizing said metadata.

16. The method of claim 15, wherein said plurality of metadata directories index a group of said plurality of metadata containers and each said metadata container object comprising metadata of at least one of said plurality of data container objects and objects hosting said plurality of metadata directories.

17. The method of claim 15, wherein said allocating comprises allocating said plurality of storage portions for storing a plurality of data segments of a file.

18. The method of claim 17, wherein said allocating comprises stripe-distributing said file to a plurality of stripes each storing one of said plurality of data segments.

19. The method of claim 15, wherein said allocating comprises receiving a plurality of multi-tiered service level assurance (SLA) requirements of a plurality of clients and associating each said client with one of said plurality of virtual data pools, and performing said allocating according to respective said multi-tiered SLA requirements.

20. The method of claim 15, further comprising monitoring access to said plurality of data containers and migrating said plurality of data containers between said plurality of storage portions according to said monitoring.
